(19) United States
(12) Patent Application Publication
(10) Pub. No.: US 2014/0370762 A1
(43) Pub. Date: Dec. 18, 2014

(54) CONNECTOR CONNECTING STRUCTURE AND VEHICLE INDOOR LAMP

(71) Applicant: Yazaki Corporation, Tokyo (JP)

(72) Inventor: Tetsuro TAKASAKI, Makinohara-shi (JP)

(73) Assignee: Yazaki Corporation, Tokyo (JP)

(21) Appl. No.: 14/474,724

(22) Filed: Sep. 2, 2014

Related U.S. Application Data
(63) Continuation of application No. PCT/JP2013/058180, filed on Mar. 13, 2013.

(30) Foreign Application Priority Data
Mar. 13, 2012 (JP) 2012-055617

(51) Int. Cl. H01R 13/58

(52) U.S. Cl. CPC H01R 13/58
USPC 439/790

(57) ABSTRACT

A connector connecting structure includes a connector that is electrically connected from outside and a connector receiving portion to which the connector is connected. The connector is made by assembling an electric wire including a conductor and an insulative sheath to an electric wire holder, and exposing the electric wire at a side to be connected to the connector receiving portion. The electric wire holder is provided with a camshaft, which is engageable to a lever to be assembled to the connector receiving portion, on side surfaces. The lever is provided with a cam groove in which the camshaft is slidably engaged and a rotation shaft which is rotatably assembled to the connector receiving portion, and is provided with an operating portion with which the lever is pressed down to assemble the rotation shafts to the connector receiving portion.

### CROSS REFERENCE TO RELATED APPLICATIONS

This application is a continuation of PCT application No. PCT/JP2013/058180, which was filed on Mar. 13, 2013 based on Japanese Patent Application (No. 2012-055617) filed on Mar. 13, 2012, the contents of which are incorporated herein by reference.

### BACKGROUND OF THE INVENTION

1. Field of the Invention

The present invention relates to a connector connecting structure including a connector and press contact blades and a vehicle indoor lamp including the connector connecting structure.

2. Description of the Related Art

Traditionally, with respect to a structure of electrically connecting a wire harness, which is wired on a ceiling or the like, to a vehicle indoor lamp which is attached to an opened part of internal decorative materials such as the ceiling in the room of a vehicle such as an automobile, a connecting structure is used which mutually fits one connector, which is fixed to the body of the vehicle indoor lamp, with another connector which is attached to one end of the wire harness, and is provided at the side of the ceiling. For example, a connecting structure of the connectors related to the vehicle indoor lamp is disclosed in the following PTL 1.

The connector connecting structure disclosed in the following PTL 1 includes a fixed connector 9 which is fixed onto the top surface of a body 2 of a vehicle indoor lamp 1, a movable connector 15 which is attached to one end of a wire harness 16, and is provided with camshafts 17 at the side surfaces, and a connector cover 11 which is fixed to the indoor ceiling side, and is provided with cam grooves 14 in which the camshafts 17 are slidably engaged.

Guide rods 6 which position the body 2 and the connector cover 11 and guide the fitting are protruded from the top surface of the body 2. Guide holes 13 are formed in the connector cover 11 in accordance with the positions of the guide rods 6.

When the guide rods 6 are inserted into the guide holes 13 of the connector cover 11, while the vehicle indoor lamp 1 moves upwards, the camshafts 17 slide in the cam grooves 14, and the movable connector 15 moves to the fixed connector 9. When the vehicle indoor lamp 1 is attached to an attached portion which is formed on the ceiling, the fixed connector 9 and the movable connector 15 are fitted, and the electrical connection of the vehicle indoor lamp 1 and the wire harness 16 is completed.
PTL 1: JP-A-2001-052813

### SUMMARY OF THE INVENTION

In the above traditional technique, if the load when connection terminals accommodated inside the connectors touch is big, a big force is required for the connection of the connectors, and there is a problem that the operativity related to connecting the connector to the vehicle indoor lamp gets worse.

Before the connectors are connected, because the movable connector rotates relative to the connector cover, the movable connector will not turn to a regulated direction when the movable connector and the fixed connector are connected, and there is a problem that the operativity related to connecting the connectors gets worse.

In addition, because when the stroke when the connectors are connected is big, it is necessary to extend the cam grooves in conformity to the stroke, there is a problem that the height of the connector cover increases, and the vehicle indoor lamp is upsized.

The present invention is made in view of the above described circumstances, and the object of the present invention is to provide a connector connecting structure and a vehicle indoor lamp which includes the connector connecting structure so that the load in connecting connectors decreases and the rotation of the connectors is prevented so that operativity is improved.

Another object of the present invention is to provide a connector connecting structure and a vehicle indoor lamp which includes the connector connecting structure so that while the length of the cam grooves necessary for connector connection is maintained, downsizing can be realized.

(1) According to an aspect of the invention, a connector connecting structure includes a connector that is electrically connected from outside; and a connector receiving portion to which the connector is connected. The connector is made by assembling an electric wire including a conductor and an insulative sheath to an electric wire holder, and exposing the electric wire at a side to be connected to the connector receiving portion. The electric wire holder is provided with a camshaft, which is engageable to a lever to be assembled to the connector receiving portion, on side surfaces. The lever is provided with a cam groove in which the camshaft is slidably engaged and a rotation shaft which is rotatably assembled to the connector receiving portion, at side face of the lever, and is provided with an operating portion with which the lever is pressed down to assemble the rotation shafts to the connector receiving portion, at one end side of a top face of the lever. The connector and the lever further includes a slider shaft which prevents the rotation of the connector at the time of operating the lever at the side face of the connector, and a slider groove to which the slider shaft is slidably engaged at the side face of the lever. The connector receiving portion has a support portion to which the rotation shaft of the lever is rotatably assembled, and a press contact blade to which the electric wire is press contacted. When the rotation shaft of the lever is assembled to the support portion and the operating portion is pushed down, the camshaft slides in the cam groove to make the connector move to the connector receiving portion, and the slider shaft slides in the slider grooves to prevent the rotation of the connector, and when the electric wire is cut into by the press contact blade, the electrical connection of the connector and the connector receiving portion is completed.

According to the present invention having the configuration (1), the connector is constructed by assembling the electric wires comprising conductors and insulative sheath to the electric wire holder, and exposing the electric wires at the end of a side connected to the connector receiving portion. The camshafts, which can be engaged to the lever which is assembled to the connector receiving portion, are provided on the side surfaces of the electric wire holder. The cam grooves, in which the camshafts are slidably engaged, and the rotation shafts, which are rotatably assembled to the connector receiving portion, are provided at the side surfaces of the lever. The operating portion, with which the lever is pressed down to assemble the rotation shafts to the connector receiving portion, is provided at the end side of the lever. The connector and the lever are further provided with the slider shafts, which prevent the rotation of the connector at the time of operating the lever, and the slider grooves, to which the slider shafts are slidably engaged, at the side surfaces of the connector and the lever. The connector receiving portion has the support portions, to which the rotation shafts of the lever are rotatably assembled, and the press contact blades, to which the electric wires are press contacted. When the rotation shafts of the lever are assembled to the support portions and the operating portion is pushed down, the camshafts slide in the cam grooves and the connector moves to the connector receiving portion. When the electric wires, which are exposed at the end of the electric holder at the side connected to the connector receiving portion, are cut into by the press contact blades to be press contacted, the electrical connection of the connector and the connector receiving portion is completed. The slider shafts slide in the slider grooves, which are provided at the connector and the lever, when the operating portion is pressed down, to prevent the rotation of the connector.

(2) In the connector connecting structure of (1), the cam groove has a connector moving section in which the camshaft slides to make the connector move towards the connector receiving portion, and a electric wire press contact section in which the camshaft slide to make the electric wire to be cut into by the press contact blade to be press contacted. In the cam groove, an angle of an inclination of the connector moving section relative to the direction in which the lever is pushed down is larger than the angle of the inclination of the electric wire press contact section.

According to the present invention having the configuration (2), the cam grooves is formed so that the angle of the inclination of the connector moving sections relative to the direction the lever is pushed down is larger than the angle of the inclination of the electric wire press contact sections. Thereby, the height of the lever can be lowered.

(3) In the connector connecting structure of (1) or (2), the connector receiving portion includes a contact surface that is formed to be perpendicular to the direction in which the lever is pushed down, and the connector moves to the press contact blade when a bottom face of the electric wire holder slides on the contact surface at the time of operating the lever.

According to the present invention having the configuration (3), the connector receiving portion includes the contact surface that is formed to be perpendicular to the direction the lever is pushed down. Thus, when the rotation shafts of the lever are assembled to the support portions of the connector receiving portion, the bottom surface of the electric wire holder abuts with the contact surface. The connector moves to the press contact blades when the bottom surface of the electric wire holder slides on the contact surface at the time of operating the lever.

(4) According to another aspect of the invention, a vehicle indoor lamp includes the connector connecting structure of any one of (1) to (3).

According to the present invention having the configuration (4), the vehicle indoor lamp includes the connector connecting structure according to any one of (1) to (3).

According to the present invention described in (1), the rotation shafts which are rotatably assemble to the support portions become fulcrums. The operating portion, with which the lever is pressed down, becomes a force point. The cam grooves in which the camshafts are slidably engaged become action points. When the operating portion is pushed down, a load larger than the load applied to the operating portion is applied to the camshafts through the cam grooves. Thereby, the fitting load in the connection of the connector and the connector receiving portion can be reduced. When the camshafts move in the cam grooves, the connector moves to the press contact blades, and the electric wires are cut into by the press contact blades to be press contacted. When the electric wires are press contacted to the press contact blades, the inside conductors are connected only by making the press contact blades cut into the insulative sheath of the electric wires. Compared with the connecting structure in which connecting terminals accommodated in the connector are contacted and conform to each other, the connector connecting structure is finished with a smaller load. Thereby, the load in the connection of the connector and the connector receiving portion can be further reduced. The connector and the lever are further provided with the slider shafts, which prevent the rotation of the connector, and the slider grooves, to which the slider shafts are slidably engaged. Thereby, the slider shafts slide in the slider grooves when the lever is pressed down, and the rotation of the connector is prevented. Therefore, an effect is achieved that operativity can be improved by lowering the load at the time of connector connection, and preventing the rotation of the connector.

According to the present invention described in (2), since the angle of the inclination of the connector moving sections is larger than the angle of the inclination of the electric wire press contact sections, the height of the cam grooves can be lowered in the height direction of the lever. Therefore, an effect is achieved that while the length of the cam grooves necessary for connection of the connector is maintained, the connecting structure can be downsized.

According to the present invention described in (3), the connector moves to the connector receiving portion in a state that the bottom surface of the electric wire holder abuts with the contact surface. Therefore, the connector can be connected to the connector receiving portion in a stable state. Therefore, an effect is achieved that the operativity can be improved.

According to the present invention described in (4), since the vehicle indoor lamp includes the connector connecting structure according to claims 1 to 3, the same effects as those of the connector connecting structures according to claims 1 to 3 are achieved.

### BRIEF DESCRIPTION OF THE DRAWINGS

FIG. 1 is an exploded perspective view of a vehicle indoor lamp including the connector connecting structure according to a first embodiment of the present invention.

FIG. 2 is a perspective view of the vehicle indoor lamp in FIG. 1.

FIG. 3 is a perspective view of the vehicle indoor lamp in FIG. 1.

FIG. 4 is a perspective view of a connector.

FIG. 5 is a perspective view of a lever.

FIGS. 6A and 6B include a perspective view and a side view which show a state that the connector is attached to the lever.

FIGS. 7A and 7B include an enlarged perspective view and a side view of a connector receiving portion.

FIGS. 8A and 8B include a perspective view and a side view which show steps of connecting the connector to the connector receiving portion.

FIGS. 9A and 9B are figures that follow FIGS. 8A and 8B.

FIG. 10 is a figure that follows FIG. 9A.

FIGS. 11A and 11B include a side view and a top view which show a state before the connector and the connector receiving portion are connected.

FIGS. 12A and 12B are figures that follow FIGS. 11A and 11B, and include a side view and a top view which show a state when electric wires start to be press contacted to press contact blades.

FIGS. 13A and 13B are figures that follow FIGS. 12A and 12B, and include a side view and a top view which show a state when the electric wires have been press contacted to the press contact blades.

FIG. 14 is a figure which shows the actions of the connector and the lever when the lever is operated.

FIG. 15 is a side view which shows a connector connecting structure according to the second embodiment of the present invention.

FIGS. 16A and 16B include a side view which show a state before a connector is connected to a connector receiving portion in FIG. 15, and an enlarged view of a part where camshafts are engaged in cam grooves.

FIGS. 17A and 17B follow FIGS. 16A and 16B, and include a side view which shows a state when electric wires start to be press contacted to press contact blades, and an enlarged view of a part where the camshafts are engaged in the cam grooves.

FIGS. 18A and 18B follow FIGS. 17A and 17B, and include a side view which shows a state when the electric wires have been press contacted to the press contact blades, and an enlarged view of a part where the camshafts are engaged in the cam grooves.

### DETAILED DESCRIPTION OF THE EXEMPLARY EMBODIMENTS

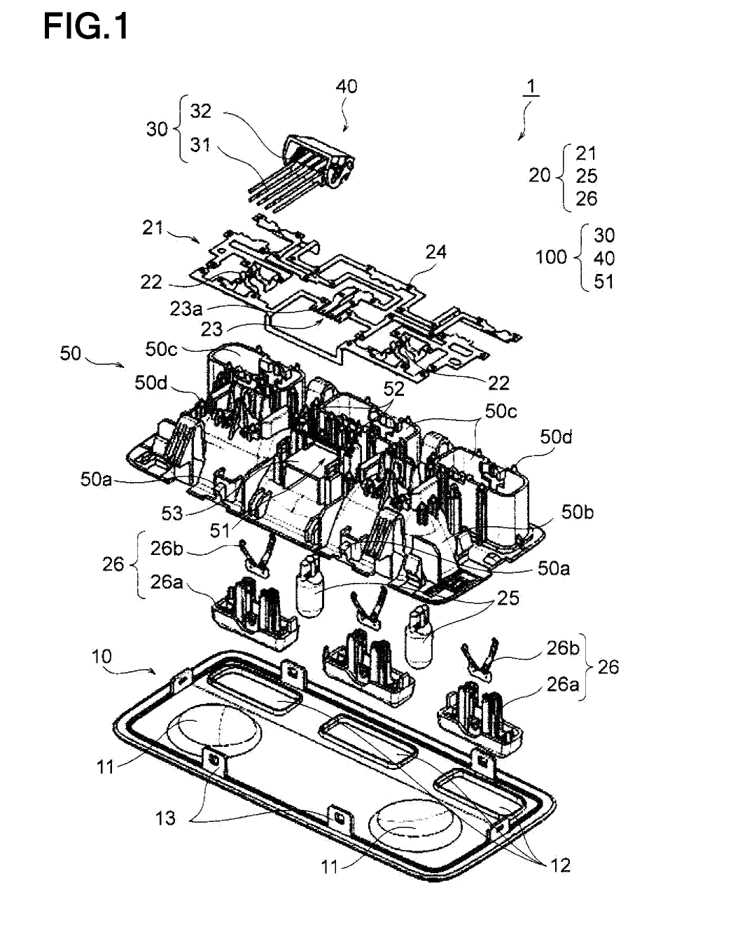

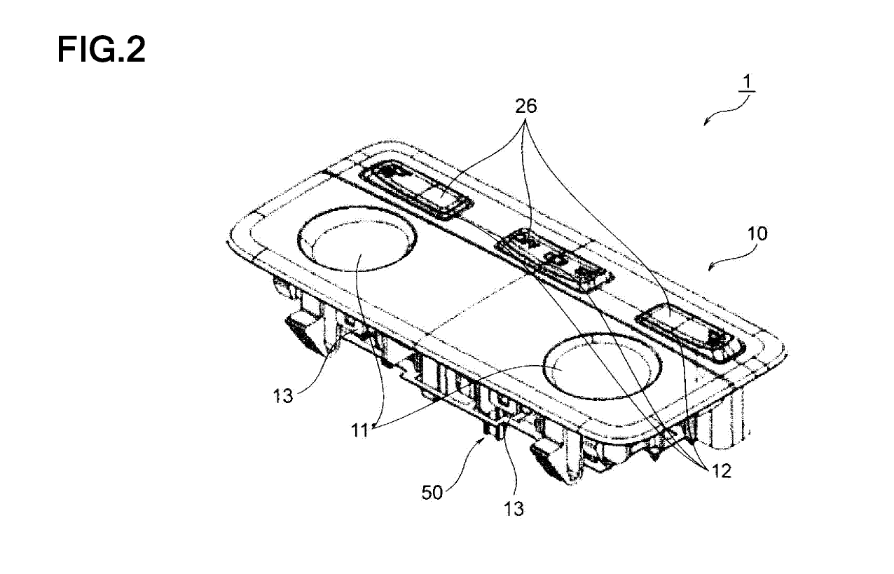

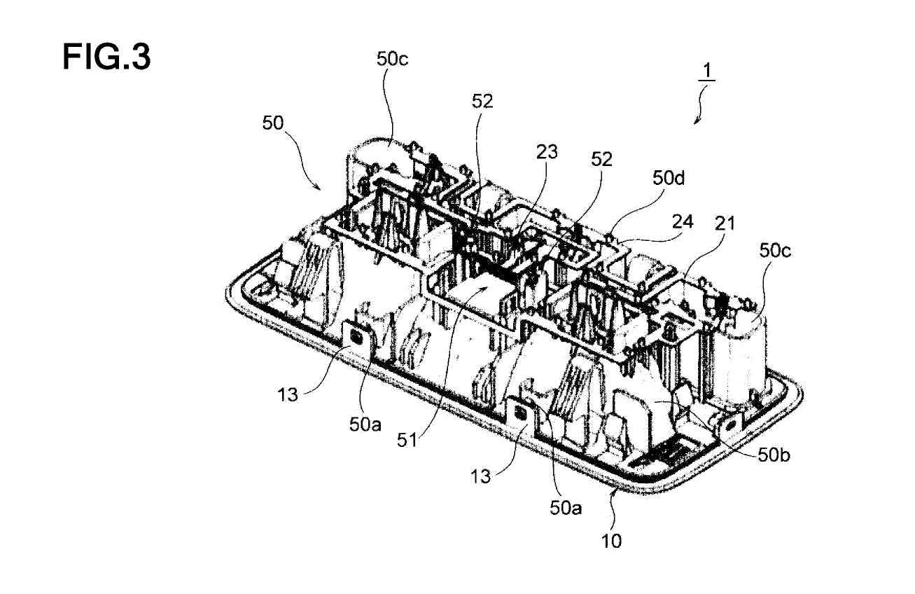

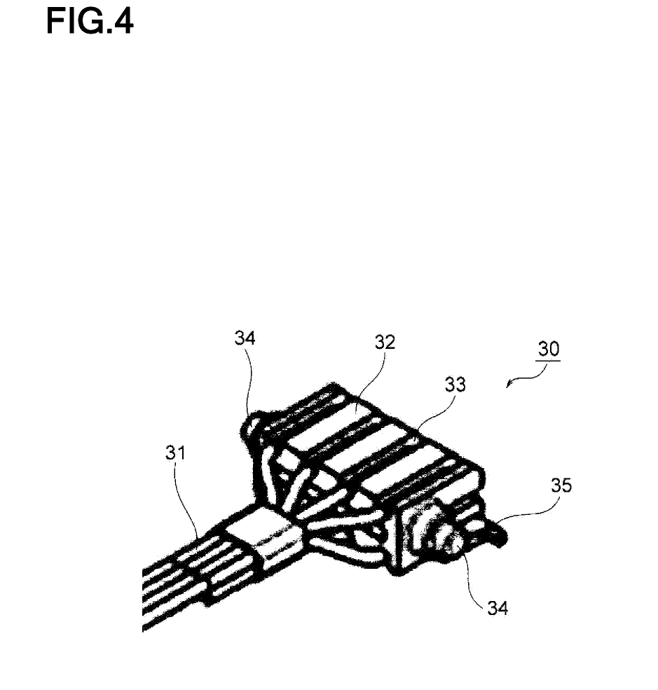

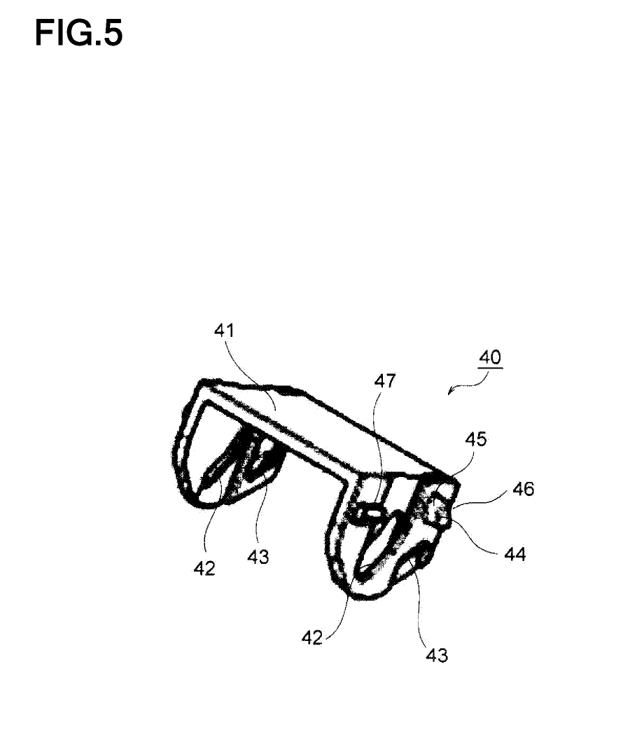

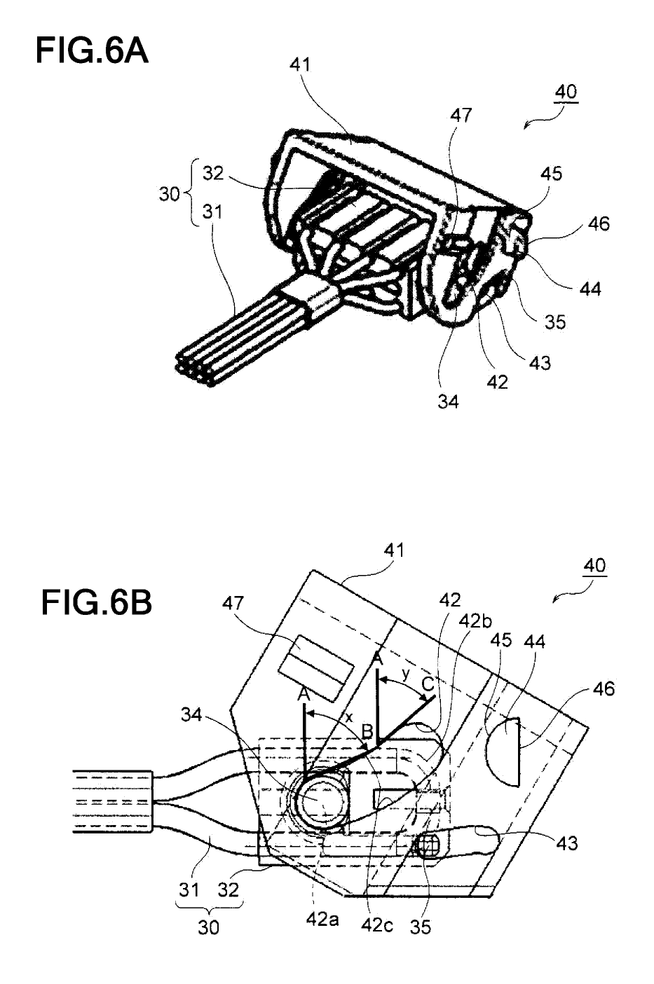

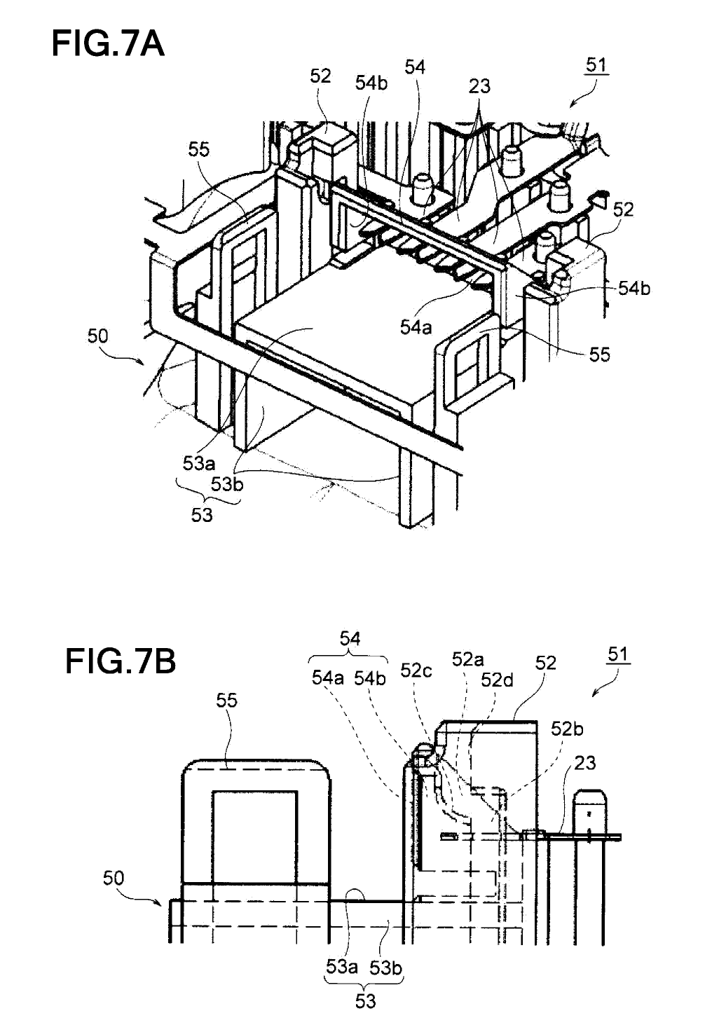

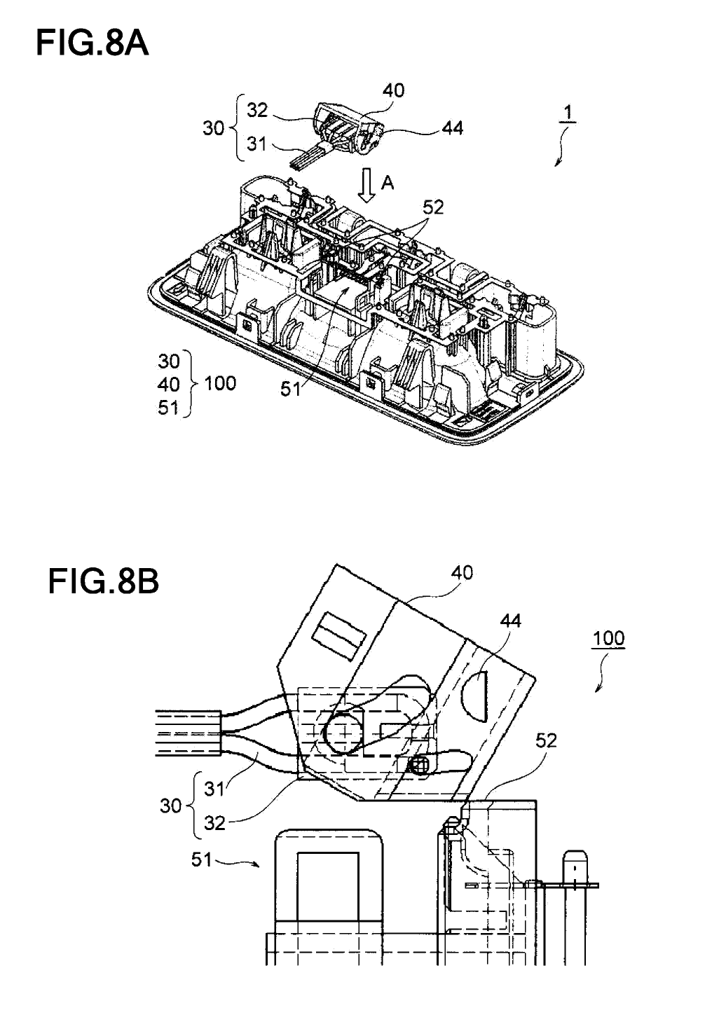

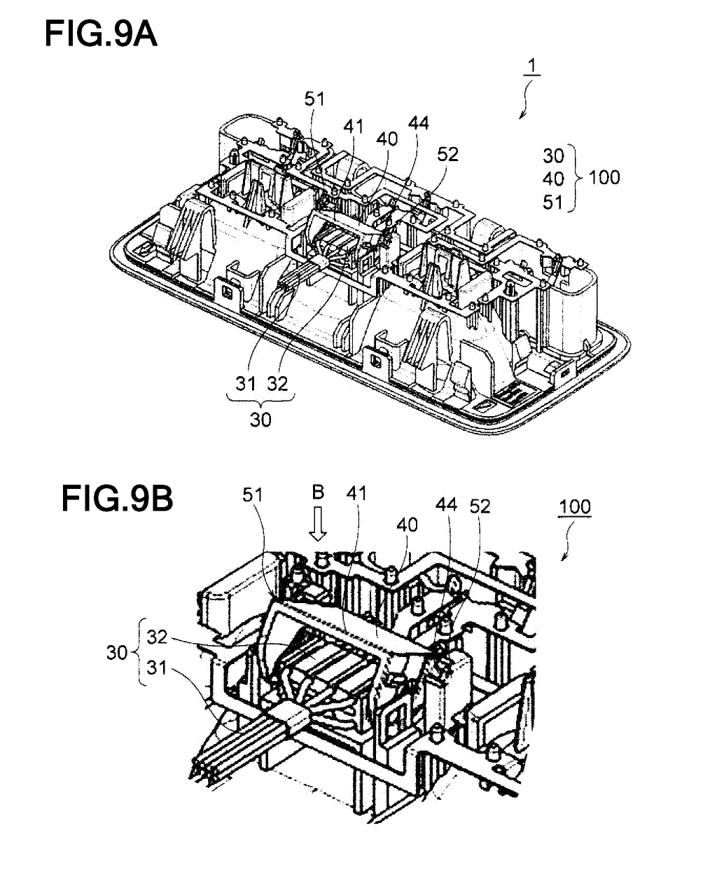

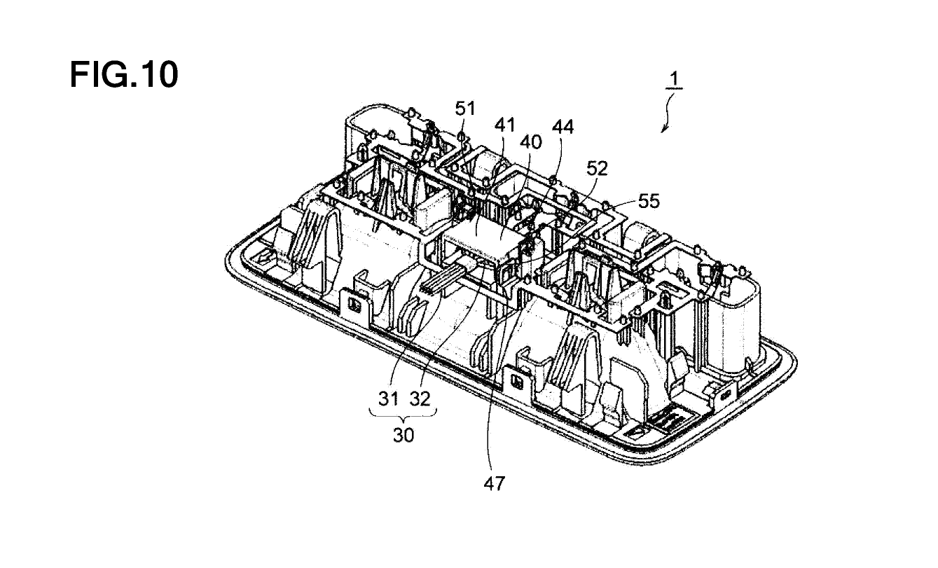

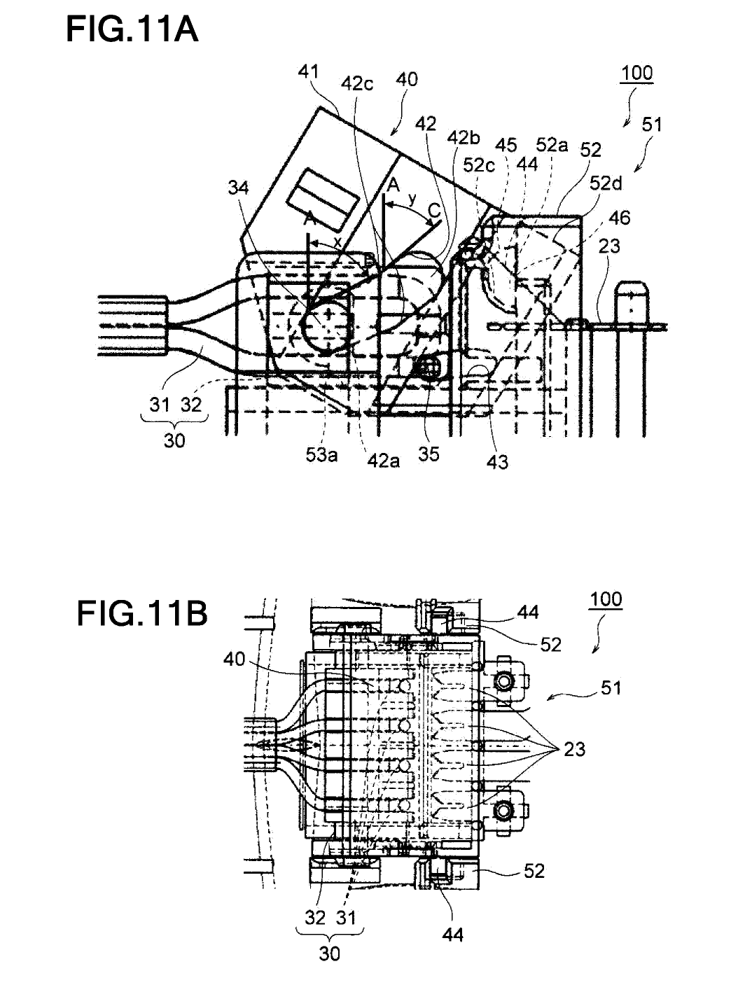

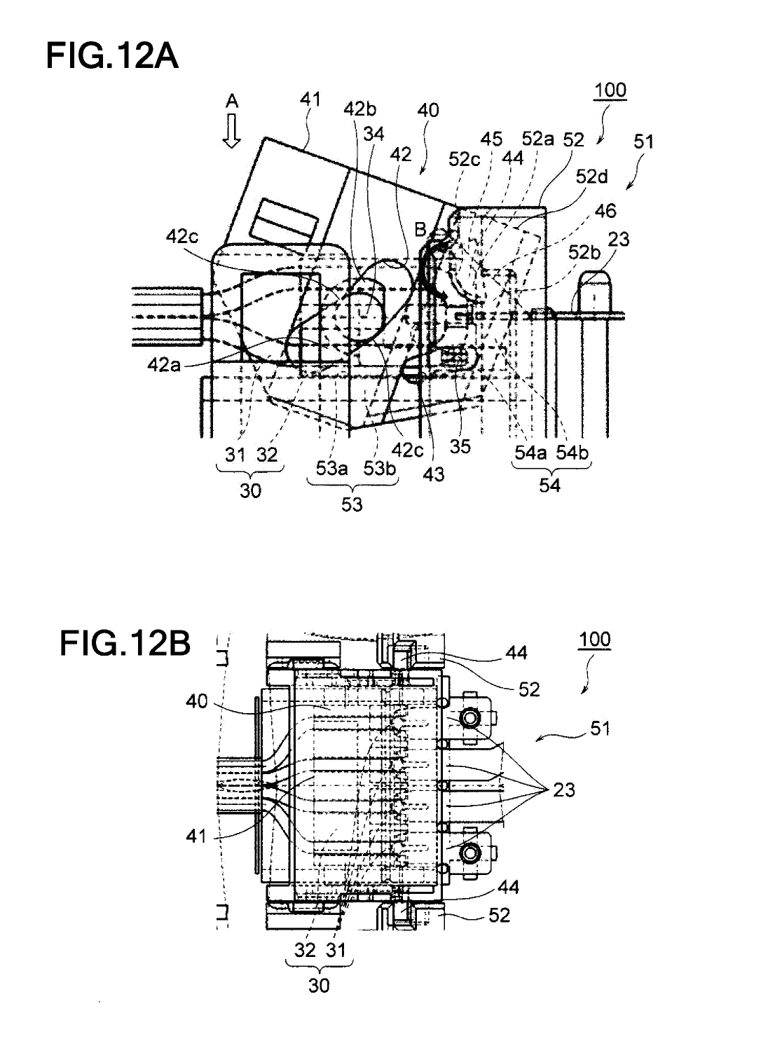

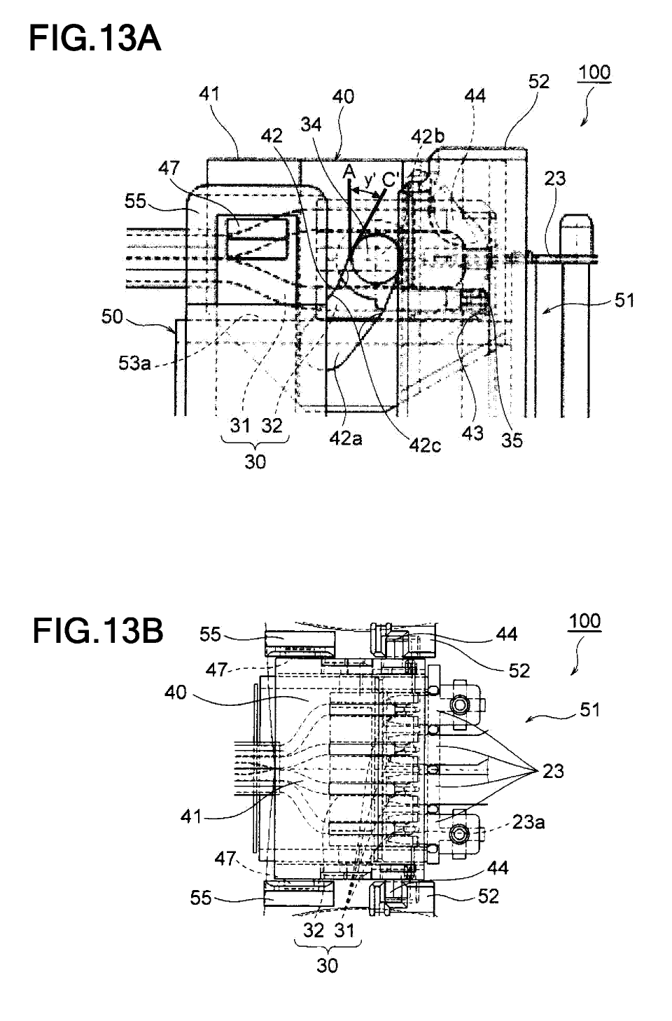

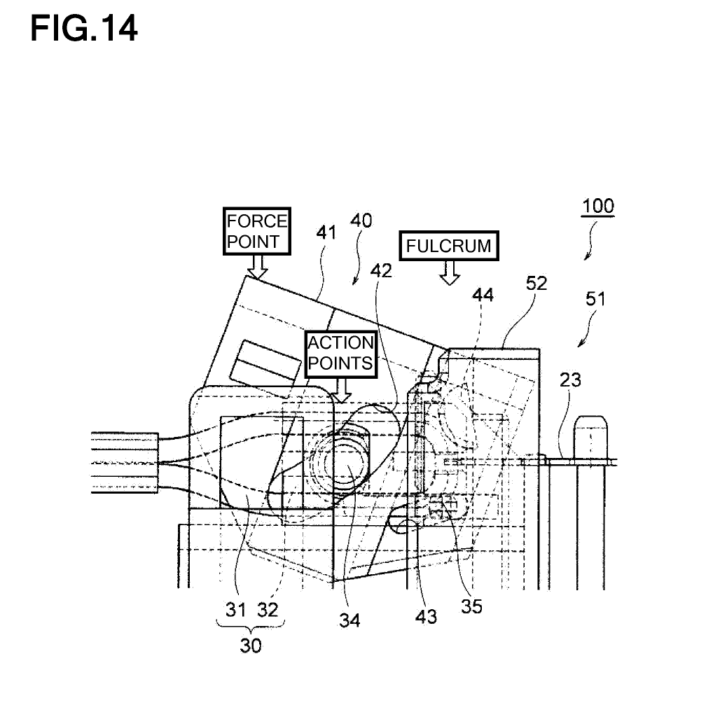

The first embodiment of the connector connecting structure according to the present invention is shown in FIGS. 1 to 14. FIG. 1 is an exploded perspective view of a vehicle indoor lamp including the connector connecting structure according to a first embodiment of the present invention. FIG. 2 is a perspective view of the vehicle indoor lamp in FIG. 1. FIG. 3 is a perspective view that shows a state before a connector is connected to the vehicle indoor lamp in FIG. 1. FIG. 4 is a perspective view of the connector. FIG. 5 is a perspective view of a lever. FIGS. 6A and 6B include a perspective view and a side view which show a state that the connector is attached to the lever. FIGS. 7A and 7B include an enlarged perspective view and a side view of a connector receiving portion. FIGS. 8A and 8B include a perspective view and a side view which show steps of connecting the connector to the connector receiving portion. FIGS. 9A and 9B are figures that follow FIGS. 8A and 8B, in which, FIG. 9A is a perspective view which shows a state of positioning the connector relative to the connector receiving portion, and FIG. 9B is an enlarged perspective view of the connector connecting structure in FIG. 9A. FIG. 10 is a figure that follows FIG. 9A, and is a perspective view which shows a state that the connector is connected to the vehicle indoor lamp. FIGS. 11A and 11B include a side view and a top view which show a state before the connector and the connector receiving portion are connected. FIGS. 12A and 12B are figures that follow FIGS. 11A and 11B, and include a side view and a top view which show a state when electric wires start to be press contacted to press contact blades. FIGS. 13A and 13B are figure that follow FIGS. 12A and 12B, and include a side view and a top view which show a state when the electric wires have been press contacted to the press contact blades. FIG. 14 is a figure which shows the actions of the connector and the lever when the lever is operated.

In FIG. 1, a reference number 1 shows a vehicle indoor lamp including a connector connecting structure 100 according to the first embodiment of the present invention. The vehicle indoor lamp 1 is not particularly limited, but may be arranged on the indoor ceiling of a vehicle such as an automobile and illuminate the indoor room. The vehicle indoor lamp 1 is electrically connected to electric wires when a plurality of electric wires 31 are press contacted to press contact blades 23. The vehicle indoor lamp 1 includes a lens 10, a lighting function portion 20, a housing 50, a connector receiving portion 51, a connector 30 and a lever 40. The lens 10 is assembled to the indoor side of a roof trim (internal decorative material) provided as a part of a roof module. The lighting function portion 20 is assembled to the outdoor side of the lens 10. The housing 50 accommodates the lighting function portion 20, and the lens 10 is assembled to the housing 50. The connector receiving portion 51 includes support portions 52 and a contact portion 53 generally in the central part of the housing 50, and is constructed when the press contact blades 23 are arranged. The connector 30 is made by assembling the plurality of electric wires 31 to an electric wire holder 32, and the connector 30 is connected to the connector receiving portion 51. The lever 40 is rotatably assembled to the support portions 52 of the connector receiving portion 51. The connector connecting structure 100 is constructed by the connector 30, the lever 40 and the connector receiving portion 51. Next, these component members are described.

In FIGS. 1 and 2, the lens 10 is molded of transparent or semitransparent synthetic resin material through which light passes, and is formed into a rectangular shape. The lens 10 has collecting portions 11, switch accommodating holes 12 and lens side fitting portions 13. The collecting portions 11 are provided at positions at one end side and the other end side of the lens 10 in the longitudinal direction. The switch accommodating holes 12 are provided to be paralleled in the longitudinal direction of the lens 10. The lens side fitting portions 13 are formed as portions to fit with the housing 50, and are provided on the circumference of the lens 10, as shown in FIGS. 2 and 3.

Next, the lighting function portion 20 is described.

In FIG. 1, the lighting function part 20 includes a plurality of busbars 21 as a circuit body, a plurality of bulbs 25 which irradiate irradiation light, and a plurality of switch members 26.

In FIG. 1, the busbars 21 are formed to have desired courses by punching and bending metal plates having conductivity. The busbars 21 have a plurality of through holes 24 to be fixed to the housing 50 at predetermined positions. The busbars 21 have power supply terminals 22, and have a plurality of press contact blades 23 to press contact the plurality of electric wires 31. The press contact blades 23 construct a part of the connector receiving portion 51, and press contact grooves 23a which are cut into a generally U-like shape are formed at the ends of the press contact blades 23. When the electric wires 31 including conductors and insulative sheaths are pressed into the press contact grooves 23a, the press contact grooves 23a cut through the insulative sheaths, and the press contact grooves 23a and the conductors are press contacted.

In this embodiment, it is exemplified that the number of the electric wires 31 is four, but the number of the electric wires 31 is not limited to four. The number of the press contact blades 23 is also not limited, and can be provided according to the number of the electric wires 31.

The bulbs 25 are portions which emit irradiation light to light up the indoor room, and known bulbs are used herein. When the bulbs 25 are accommodated in bulb accommodating portions 50b of the housing 50, the bulbs 25 electrically contact the power supply terminals 22 of the busbars 21.

The switch members 26 are members that change operation states (ON/OFF) of the bulbs 25, and are made by assembling contacts 26b to switch knobs 26a. When the switch members 26 are accommodated in switch accommodating portions 50c of the housing 50, and the lens 10 is assembled in the housing 50, as shown in FIG. 2, the switch members 26 face the indoor side from the switch accommodating holes 12. When the switch members 26 is connected to the power supply terminals 22 of the busbars 21 through the contacts 26b, the bulbs 25 can be electrified.

Next, the connector 30 is described.

In FIG. 4, the connector 30 is constructed by assembling the plurality of electric wires 31 in the electric wire holder 32. The electric wire holder 32 has an electric wire holding portion 33, camshafts 34 and slider shafts 35.

The electric wire holding portion 33 is provided as groove-like portions to accommodate the plurality of electric wires 31 in a bent (returned) state. The bent portions of the electric wires 31 are held in the electric wire holder 32 in a state that the ends of the electric wires 31 at the side to be connected to the connector receiving portion 51 (Refer to FIGS. 1 and 3, and do the same below) are exposed. When the press contact blades 23 (Refer to FIGS. 1 and 3, and do the same below) are pressed against the bent portions of the electric wires 31, the plurality of electric wires 31 are press contacted to the press contact blades 23.

A pair of the camshafts 34 and a pair of the slider shafts 35 are provided at the side surfaces of the electric wire holder 32, respectively.

The camshafts 34 are cylindrically projected generally from the central parts on the side surfaces of the electric wire holder 32. The camshafts 34 are slidably engaged to the lever 40 (Refer to FIG. 1, and do the same below), and are provided as portions on which a load is applied by the operation of the lever 40. The slider shafts 35 are projected from the side surfaces of the electric wire holder 32 near the ends at the side to be connected to the connector receiving portion 51. The slider shafts 35 are provided as portions which are slidably engaged to the side of the lever 40, and which prevent rotation of the connector 30 relative to the lever 40.

Next, the lever 40 is described.

In FIGS. 5 and 6, the lever 40 has a structure that can be engaged with the connector 30, and is a member to make the connector 30 to move towards the press contact blades 23 and make the electric wires 31 connect to the press contact blades 23 when an operation of assembling the lever 40 to the support portions 52 (Refer to FIG. 1, and do the same below) of the connector receiving portion 51 is performed. The lever 40 has an operating portion 41 at the end side on the top surface, and a pair of cam grooves 42, a pair of slider grooves 43, a pair of rotation shafts 44 and a pair of lever locking portions 47 at side surfaces.

The operating portion 41 is formed as a portion to operate the lever 40. The lever 40 is operated by pushing down the operating portion 41 when the connector 30 is connected to the connector receiving portion 51. The lever 40 is operated by raising the operating portion 41 when the connector 30 is removed from the connector receiving portion 51.

The cam grooves 42 are at the side surfaces of the lever 40 where the camshafts 34 are slidably engaged, and the cam grooves 42 are formed (cut) into a groove shape as portions to transfer the load that is applied to the operating portion 41 at the time of operating the lever 40 to the camshafts 34. In FIG. 6B, the cam grooves 42 are formed into a generally arc-like shape from a lower left part through a generally central part to the upper right side of the generally central part in the side surfaces of the lever 40 in the figure. The cam groove 42 has a pair of elbows 42c in the generally central part in the longitudinal direction, and with the pair of elbows 42c as borders, a left side section of the cam groove 42 in the figure is provided as a connector moving section 42a, and a right side section of the cam groove 42 in the figure is provided as an electric wire press contact sections 42b.

The connector moving sections 42a are sections where the camshafts 34 slide in the cam grooves 42 in a period since the lever 40 is rotatably assembled to the support portions 52 of the connector receiving portion 51 in a state that the connector 30 is engaged with the lever 40, the operating portion 41 is pushed, and the connector 30 starts to move towards the direction of the press contact blades 23 until the electric wires 31 start to abut and be press contacted with the press contact blades 23. The connector moving sections 42a are formed into a generally arc-like shape from the lower left parts to the upper right in the side surfaces of the lever 40, are bent to form the elbows 42c after arriving at the generally central parts of the side surfaces of the lever 40, and are formed to follow the electric wire press contact sections 42b. The electric wire press contact sections 42b are sections where the camshafts 34 slide in the cam grooves 42 in a period since the electric wires 31 start to abut and be press contacted with the press contact blades 23 until the electric wires 31 have been press contacted with the press contact blades 23. The electric wire press contact sections 42b are formed into a generally arc-like shape from the elbows 42c to the upper right sides of the generally central parts in the side surfaces of the lever 40.

The cam grooves 42 are formed so that an angle between the direction the operating portion 41 is pushed down at the time of operating the lever 40 and the connector moving sections 42a is larger than an angle between the direction the operating portion 41 is pushed down and the electric wire press contact sections 42b. That is, in FIG. 6B, when the direction the operating portion 41 is pushed down is shown with a straight line A and the inclination of the connector moving section 42a to the straight line A (the direction the operating portion 41 is pushed down) is shown with a straight line B, the angle of the inclination is x. When the inclination of the electric wire press contact sections 42b to the straight line A (the direction the operating portion 41 is pushed down) is shown with a straight line C, the angle of the inclination is y. The cam grooves 42 are formed so that the angle x is larger than the angle y.

The slider grooves 43 are formed so that the slider shafts 35 provided on the side surfaces of the electric wire holder 32 are slidably engaged, and are cut into a groove shape as portions for preventing a rotation of the connector 30 relative to the lever 40 at the time of operating the lever 40. In FIG. 6B, the slider groove 43 is formed into a horizontally extended shape at the lower right part in the side surface of the lever 40 in the figure, and has a portion which has such a shape that the fringe of the right terminal of the slider groove 43 is projected downwards into a generally arc-like shape.

In the embodiment, the slider shafts 35 are provided on the side surfaces of the electric wire holder 32 and the slider grooves 43 are provided in the side surfaces of the lever 40, but the invention is not limited to this. That is, it is also possible that the slider grooves 43 are provided in the side surfaces of the electric wire holder 32 and slider shafts 43 are provided on the side surfaces of the lever 40 at the inner side of the lever 40.

The rotation shafts 44 are provided as portions to rotatably assemble the lever 40 to the support portions 52 of the connector receiving portion 51. In FIG. 6B, the rotation shafts 44 are provided at the upper right parts on the side surfaces of the lever 40 in the figure, and the end faces of the rotation shafts 44 are formed into a generally semi-circular shape. Those parts of the rotation shafts 44 having the above shape that are formed into a generally arc-like shape are provided as arc portions 45, and those parts of the rotation shafts 44 that are formed into a straight line are provided as straight line portions 46.

The lever locking portions 47 are formed into a projected shape as portions to engage the lever 40 with the housing 50 (Refer to FIGS. 1 and 3 and do the same below) when the operating portion 41 is pushed down at the time of operating the lever 40.

The lever 40 can be rotatably attached to the support portions 52 of the connector receiving portion 51 in a state of being engaged with the connector 30. The engagement of the lever 40 to the connector 30 is performed by engaging the camshafts 34 in the cam grooves 42 and by engaging the slider shafts 35 in the slider grooves 43. While the pair of camshafts 34 of the connector 30 are engaged in the pair of cam grooves 42, the pair of slider shafts 35 of the connector 30 are engaged in the pair of slider grooves 43. Therefore, there are four places where the connector 30 is engaged with the lever 40.

Next, the housing 50 is described.

In FIG. 1, the housing 50 is a member assembled to the outdoor side of the lens 10 and molded of synthetic resinous material, and has a plurality of locking portions which are locked to the roof trim. In FIGS. 2 and 3, the housing 50 is assembled to the lens 10 after the lighting function portion 20 (Refer to FIG. 1, and do the same below) is incorporated. In FIG. 1, the housing 50 has housing side fitting portions 50a with which the lens 10 are fitted, a plurality of bulb accommodating portions 50b which accommodate the bulbs 25, a plurality of switch accommodating portions 50c which accommodate the switch members 26, a plurality of busbar fixing portions 50d which fix the busbars 21, and the support portions 52, the contact portion 53, a connection guide portion 54 (refer to FIGS. 7A and 7B) and lever locked portions 55 (refer to FIGS. 7A and 7B) which become a part of the connector receiving portion 51 to be described below. The busbar fixing portions 50d are projected from the top surface of the housing 50 in accordance with the positions and number of the through holes 24 formed in the busbars 21. In the embodiment, the busbar fixing portions 50d are constructed to fix the busbars 21 to the housing 50 by making welding pins heat welded after the weld pins which are protruded from the top surface of the housing 50 are inserted through the through holes 24.

In FIGS. 7A and 7B, the connector receiving portion 51 includes the support portions 52, the contact portion 53, the connection guide portion 54 and the lever locked portions 55, and is constructed by containing the press contact blades 23 which are arranged on the top surface of the housing 50 when the busbars 21 are assembled to the housing 50, as shown in FIG. 3. That is, the connector receiving portion 51 is constructed to include components of the housing 50 and the busbars 21.

The support portions 52 are portions to which the rotation shafts 44 (refer to FIGS. 5 and 6) of the lever 40 can be rotatably assembled, and a pair of the support portions 52 are projected into a columnar shape from the top surface of the housing 50. The distance between the pair of support portions is formed to be larger than the size of the lever 40 in the widthwise direction. In FIG. 7B, the support portions 52 have shaft receiving grooves 52a, and groove portions 52b, shaft receiving walls 52c and protruding walls 52d.

The shaft receiving grooves 52a are portion into which the rotation shafts 44 are rotatably inserted, and are formed (cut) in such a size that the rotation shafts 44 can be inserted downwards from the upper end edges of the support portions 52. The groove portions 52b are portions that follow the lower end sides of the shaft receiving grooves 52a, and are formed into a groove shape along the height direction of the support portions 52. The shaft receiving walls 52c are portions with which the rotation shafts 44 slidably abut, and are formed into a generally arc-like shape in accordance with the shape of the arc portions 45 of the rotation shafts 44. The protruding walls 52d are formed to abut with the upper half of the straight line portions 46 in the rotation shafts 44 when the rotation shafts 44 are inserted into the shaft receiving grooves 52a. Thereby, the lower half of the straight line portions 46 will not abut with the protruding walls 52d.

The contact portion 53 is provided in a state of being held between the above pair of support members 52, and has a contact surface 53a and leg portions 53b that follow the contact surface. The contact surface 53a is formed into a horizontal thin board-like shape on the top surface of the housing 50. The contact surface 53a is formed as a portion which can contact the bottom surface of the electric wire holder 32 (Refer to FIGS. 6A and 6B and do the same below) which is engaged with the lever 40 when the lever 40 is assembled to the support portions 52. The contact surface 53a is formed as a portion on which the connector 30 is slidable at the time of operating the lever 40. The leg portions 53b are formed to follow two ends of the contact surface 53a, and extend towards the top surface of the housing 50 generally perpendicular to the contact surface 53a. The leg portions 53b have a predetermined height to position the connector 30 to such a height that the electric wires 31 can be press contacted with the press contact blades 23 when the connector 30 is connected to the connector receiving portion 51.

The connection guide portion 54 is provided to cover the terminals of the press contact blades 23, and have a through portion 54a which is formed in such a size that the connector 30 can be inserted through, and connection guide walls 54b which are formed to follow two ends of the through portion 54a. A pair of the connection guide walls 54b is included, and the distance between the pair of connection guide walls 54b may allow the connector 30 to enter.

The lever locked portions 55 are portions to engage the lever locking portions 47 which the lever 40 has and to fix the lever 40 to the housing 50, and a pair of the lever locked portions 55 are projected from the top surface of the housing 50 to be near the support portions 52 and hold the contact portion 53.

Next, steps of assembling the vehicle indoor lamp 1 are described.

As a first step, first, the busbars 21 (Refer to FIG. 1 and do the same below) are assembled on the top surface of the housing 50 (Refer to FIG. 1 and do the same below). When the busbars 21 are assembled, the busbar fixing portions 50d (Refer to FIG. 1 and do the same below) provided on the top surface of the housing 50 are inserted through the plurality of through holes 24 formed in the busbars 21. Thereby, the power supply terminals 22 (Refer to FIG. 1 and do the same below) of the busbars 21 are arranged in the bulb accommodating portions 50b (Refer to FIG. 1 and do the same below) which are formed in the housing 50. When the press contact blades 23 are arranged generally in the central part of the top surface of the housing 50 provided with the support portions 52 (Refer to FIG. 1 and do the same below) and the contact portion 53 (Refer to FIG. 1 and do the same below), the connector receiving portion 51 (refer to FIGS. 7A to 7C) is constructed.

Then, the busbars 21 are fixed on the top surface of the housing 50. As described above, the busbar fixing portions 50d are constructed by making the welding pins to be projected from the top surface of the housing 50, and after the welding pins (the busbar fixing portions 50d) are inserted through the through holes 24 and the busbars 21 are assembled to the housing 50, the welding pins are heat welded to make the busbars 21 fix onto the top surface of the housing 50.

Then, as a second step, the contacts 26b (Refer to FIG. 1 and do the same below) are assembled to the switch knobs 26a (Refer to FIG. 1 and do the same below), and the switch members 26 are made.

Further, as a third step, the switch members 26 are accommodated in the switch accommodating portions 50c (Refer to FIG. 1 and do the same below) which is provided in the housing 50 to which the busbars 21 are fixed in the first step. The accommodation of the switch members 26 is performed by first inserting the side of the contacts 26b from the bottom side of the housing 50 to the switch accommodating portions 50c.

Then, as a fourth step, the bulbs 25 (Refer to FIG. 1 and do the same below) are installed into the housing 50 which was subject to the above first to third steps. The bulbs 25 are installed by inserting the bulbs 25 into the bulb accommodating portions 50b, which are provided in the housing 50, from the bottom side of the housing 50. The bulbs 25 electrically touch the power supply terminals 22 arranged in the bulb accommodating portions 50b. Thereby, the assembly of the lighting function portion 20 (Refer to FIG. 1 and do the same below) to the housing 50 is completed.

Then, as a fifth step, the lens 10 (Refer to FIG. 1 and do the same below) is assembled to the housing 50 for which the assembly of the lighting function portion 20 is completed. The assembly of the lens 10 to the housing 50 is performed when the internal side of the lens 10 turns to the bottom side of the housing 50. The lens side fitting portions 13 formed in the lens 10 are fitted with the housing side fitting portions 50a (refer to FIG. 1) formed in the housing 50, and the lens 10 and the housing 50 are assembled. By the above, the assembly of the vehicle indoor lamp 1 (refer to FIGS. 2 and 3) is completed.

Next, steps of assembling the connector 30 are described.

As a first step, the electric wires 31 (Refer to FIG. 4 and do the same below) are assembled to the electric wire holder 32 (Refer to FIG. 4 and do the same below). The related assembly is performed by using a wire harness wiring jig board (hereinafter referred to a jig board). The jig board has a generally square board-like shape, and a plurality of wiring guide bars for bending the electric wires 31 to be wired in desired positions are raised on the top surface of the jig board. On the top surface of the jig board, a setting portion is provided to arrange the electric wire holder 32 at a predetermined position at the time of assembling the electric wires 31. First, the electric wire holder 32 is set on the setting portion with the end of the electric wire holder 32 at the side to be connected to the connector receiving portion 51 (Refer to FIG. 1 and do the same below) facing upwards.

Then, as a second step, the electric wires 31 are bent with the wiring guide bars and wired on the jig board. In this way, the electric wires 31 are wired right above the end of the electric wire holder 32 at the side to be connected to the connector receiving portion 51. The assembly of the electric wires 31 to the electric wire holder 32 is performed by bending to return the electric wires 31 to be accommodated in the electric wire holding portion 33 (refer to FIG. 4). The bent portions of the electric wires 31 are exposed at the end of the electric wire holder 32 at the side to be connected to the connector receiving portion 51.

Then, as a third step, the electric wire holder 32 and the electric wires 31 are removed from the jig board after the electric wires 31 have been assembled to the electric wire holder 32. The electric wires 31 are tape wound and bundled. By the above, the assembly of the connector 30 is completed. The engagement of the lever 40 (refer to FIG. 5) with the connector 30 is performed by making the sides of the lever 40 flex to clamp the side surfaces of the electric wire holder 32 so that while the camshafts 34 are engaged in the cam grooves 42, the slider shafts 35 are engaged in the slider grooves 43.

Then, with reference to FIGS. 8 to 10, steps of connecting the connector 30 to the connector receiving portion 51 are described.

In FIGS. 8A and 8B, first, after the connector 30 is engaged with the lever 40, the connector 30 and the lever 40 are assembled to the support portions 52 of the connector receiving portion 51 with the rotation shafts 44 of the lever 40 towards a direction shown with an arrow A.

In FIG. 9A, the connector 30 is positioned by assembling the rotation shafts 44 of the lever 40 to the support portions 52. Then, in FIG. 9B, when the operating portion 41 of the lever 40 is pushed down in the direction shown with an arrow B, the rotation shafts 44 rotate on the support portions 52.

In FIG. 10, when the lever 40 is pushed down till the last, the lever locking portions 47 are locked to the lever locked portions 55. By the above, the connection of the connector 30 to the connector receiving portion 51 is completed.

Then, with reference to FIGS. 11A to 14, actions of the lever 40 and the connector 30 at the time of operating the lever 40 are described in detail. In FIGS. 11A and 11B, first, the rotation shafts 44 of the lever 40 are inserted into the shaft receiving grooves 52a in the support portions 52. The arc portions 45 of the rotation shafts 44 inserted into the shaft receiving grooves 52a abut with the shaft receiving walls 52c, and the upper half of the straight line portions 46 abut with the protruding walls 52d. When the rotation shafts 44 are assembled to the support portions 52, the bottom surface of the electric wire holder 32 abuts with the contact surface 53a, and the positioning of the connector 30 to the connector receiving portion 51 is completed. In this state, as shown in FIG. 11A, the camshafts 34 are located at the left ends of the cam grooves 42 in the figure, and the slider shafts 35 are located at the left ends of the slider grooves 43 in the figure.

In FIG. 11A, after the positioning of the connector 30 to the connector receiving portion 51 is completed, the angle of the inclination (the illustrated straight line B) of the connector moving sections 42a relative to the direction the operating portion 41 is pushed down (the illustrated straight line A) is x, and the angle of the inclination (the illustrated straight line C) of the electric wire press contact sections 42b relative to the direction the operating portion 41 is pushed down (the illustrated straight line A) is y. In this state, the angle x of the inclination of the connector moving sections 42a is larger than the angle y of the inclination of the electric wire press contact sections 42b.

In FIG. 12A, when the operating portion 41 of the lever 40 is pushed down towards the direction shown with an arrow A, the arc portions 45 of the rotation shafts 44 slide on the shaft receiving walls 52c, and part of the rotation shafts 44 enter into the groove portions 52b from the shaft receiving grooves 52a. Thereby, the rotation shafts 44 rotate in the direction shown with an arrow B. A load due to the pressing of the lever 40 is applied to the camshafts 34 through the cam grooves 42. Thereby, the camshafts 34 slide in the connector moving section 42a, and the connector 30 starts to move towards the press contact blades 23 while the bottom surface of the electric wire holder 32 slides on the contact surface 53a. At the same time, the slider shafts 35 slide in the slider grooves 43 in the direction the connector 30 moves.

In FIG. 12A, while the camshafts 34 arrive at the elbows 42c in the cam grooves 42, the connector 30 is inserted into the through portion 54a of the connection guide portion 54, and the electric wires 31 which are assembled to the electric wire holder 32 start to abut and be press contacted with the press contact blades 23. The electric wires 31 start to be press contacted in a state that the connector 30 turns to a regulated direction when the connector is connected due to the through portion 54a and the connection guide walls 54b (refer to FIG. 12B). When the electric wires 31 start to be press contacted, the camshafts 34 stop sliding in the connector moving sections 42a, enter into the electric wire press contact sections 42b, and start sliding in the electric wire press contact sections 42b.

In FIGS. 13A and 13B, when the operating portion 41 is further pushed down to the final point, the press contact blades 23 cut into the insulative sheaths of the electric wires 31, and the conductors are press contacted to the press contact blades 23a (refer to FIG. 13B). By the above, the electrical connection of the connector 30 and the connector receiving portion 51 is completed. At the same time, the camshafts 34 abut with the fringes of the right ends of the cam grooves 42 in the figure, and stop sliding. The slider shafts 35 abut with the fringes of the right ends of the slider grooves 43 in the figure, and stop sliding. Furthermore, when the lever locking portions 47 are locked to the lever locked portions 55, the lever 40 is fixed to the housing 50.

When the press contact of the electric wires 31 is completed, the angle of the inclination (the illustrated straight line C′) of the electric wire press contact sections 42b relative to the direction (the illustrated straight line A) the operating portion 41 is pushed down becomes y′.

In FIG. 14, when the operating portion 41 is pushed down, the operating portion 41 functions as a force point, and the bottom surface of the press contact blades 23 to which the electric wires 31 are press contacted function as a fulcrum. The cam grooves 42 which apply a load to the camshafts 34 function as action points. Thereby, when the lever 40 is operated, a load bigger than the load that is applied to the operating portion 41 is applied to the camshafts 34 through the cam grooves 42. Therefore, connection load of the connector 30 and the connector receiving portion 51 can be reduced.

For the connector connecting structure 100 according to the present embodiment, the press contact blades 23 are connected to the conductors only by cutting into the insulative sheaths of the electric wires 31. Compared with the connecting structure in which connecting terminals accommodated in the connector 30 are contacted and conform to each other, the connector connecting structure 100 is finished with a smaller connection load. Therefore, the load in the connection of the connector 30 and the connector receiving portion 51 can be further reduced. Because the connector 30 is engaged to the lever 40 at totally four places of the pair of camshafts 34 and the pair of slider shafts 35, when the connector 30 is connected, it can be prevented that the connector 30 rotates relative to the lever 40.

In FIG. 11A, the angle x of the inclination (the illustrated straight line B) of the connector moving sections 42a relative to the direction the operating portion 41 is pressed down (the illustrated straight line A) is larger than the angle y of the inclination (the illustrated straight line C) of the electric wire press contact sections 42b relative to the above straight line A. Because the connector 30 is only moved towards the press contact blades 23 before the electric wires start to be press contacted, a load smaller than the load necessary for the press contact of the electric wires 31 is enough. Thereby, the angle of the inclination of the connector moving sections 42a before the electric wires start to be press contacted can be larger than the angle of the inclination of the electric wire press contact sections 42b, and the height of the cam grooves 42 can be lowered in the height direction of the lever 40.

Furthermore, the angle y′ in FIG. 13A is smaller when the angle y of the inclination of the electric wire press contact sections 42b in FIG. 11A and the angle y′ of the inclination (the illustrated straight line C′) of the electric wire press contact sections 42b relative to the direction (the illustrated straight line A) the operating portion 41 is pushed down in FIG. 13A are compared. Thereby, by decreasing the angle of the inclination of the electric wire press contact sections 42b after the electric wires start to be press contacted, the effect of the slopes is raised, and the load when the connector 30 and the connector receiving portion 51 are connected is lowered.

In FIGS. 11 to 13, since the bottom surface of the electric wire holder 32 slides on the contact surface 53a at the time of operating the lever 40, the connector 30 can be moved towards the press contact blades 23 in a stable state, and the electric wires 31 can be press contacted to the press contact blades 23.

As described with reference to FIGS. 1 to 14, according to the present embodiment of the above construction, operativity can be improved by reducing the load when the connector 30 is connected and preventing the rotation of the connector 30.

In addition, while the length of the cam grooves 42 necessary for connection of the connector 30 is maintained, the connecting structure 100 can be downsized.

The connector 30 can be connected to the connector receiving portion 51 in a stable state, and operativity can be improved.

The vehicle indoor lamp 1 including the connector connecting structure 100 according to the present embodiment achieves the same effect as that of the connector connecting structure 100 of the above construction.

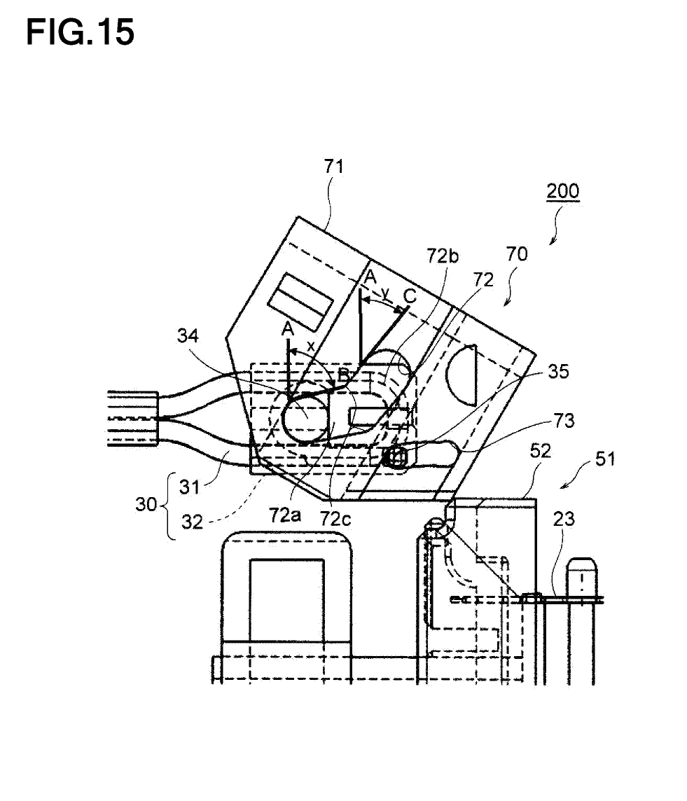

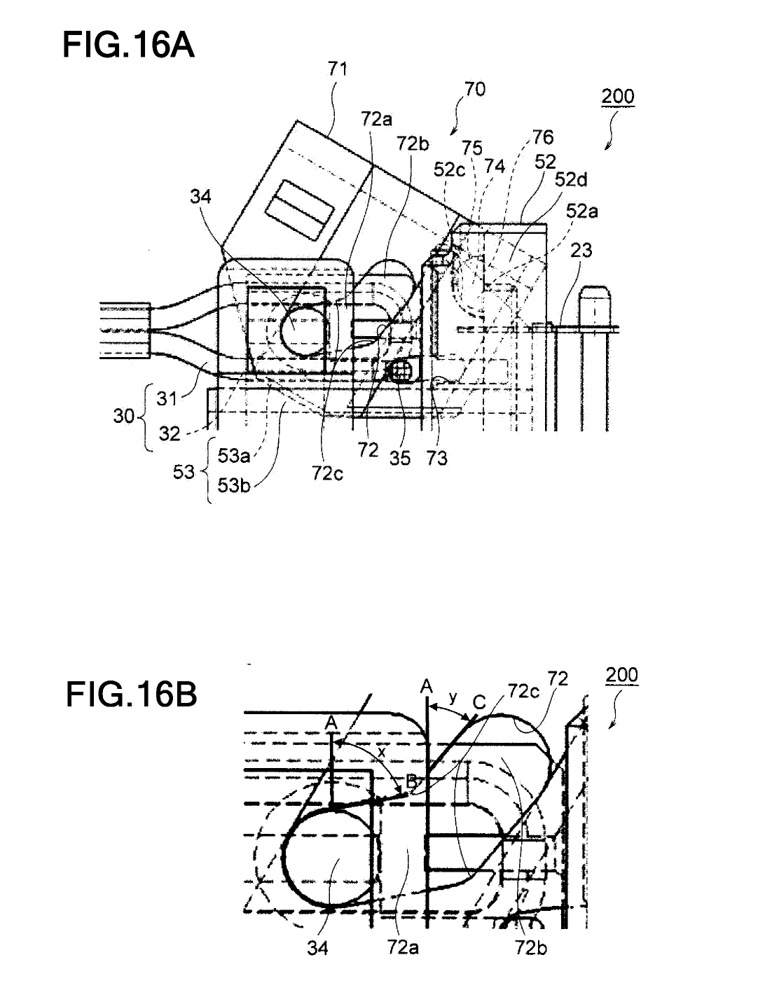

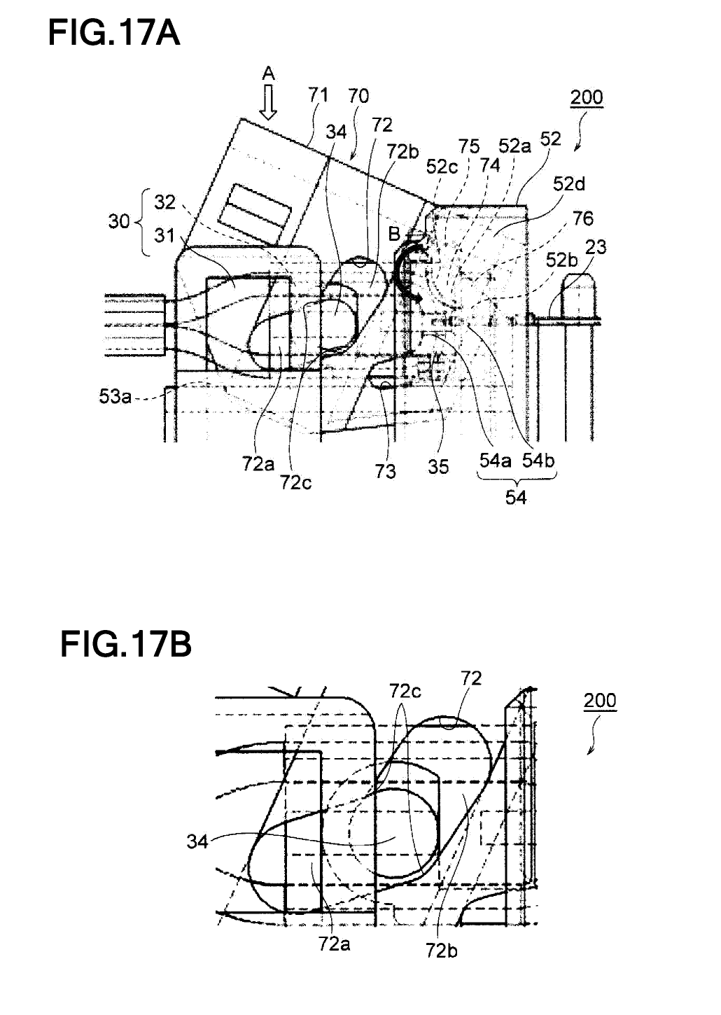

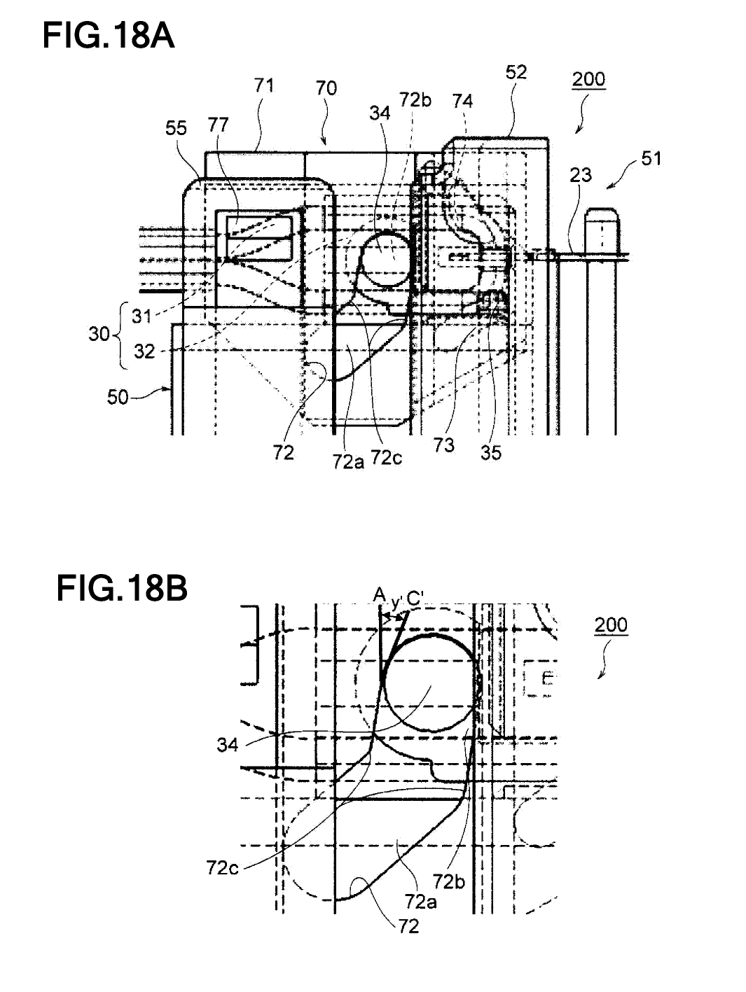

A second embodiment is described with reference to FIGS. 15 to 18 as follows. FIG. 15 is a side view which shows a connector connecting structure according to the second embodiment of the present invention. FIGS. 16A and 16B are figures which show a state before a connector is connected to a connector receiving portion in FIG. 15, in which FIG. 16A is a side view of the connector connecting structure, and FIG. 16B is an enlarged view of a part where camshafts and cam grooves are engaged in FIG. 16A. FIGS. 17A and 18B are figures that follow FIGS. 16A and 16B, in which FIG. 17A is a side view of the connector connecting structure when electric wires start to be press contacted to press contact blades, and FIG. 17B is an enlarged view of a part where the camshafts and the cam grooves are engaged in FIG. 17A. FIGS. 18A and 18B are figures that follow FIGS. 17A and 17B, in which FIG. 18A is a side view of the connector connecting structure when the electric wires have been press contacted to the press contact blades, and FIG. 18B is an enlarged view of a part where the camshafts and the cam grooves are engaged in FIG. 18A.

In FIG. 15, a vehicle indoor lamp including a connector connecting structure 200 according to the second embodiment includes a lever 70. Cam grooves 72 are provided at the side surfaces of the lever 70. The cam grooves 72 are at the side surfaces of the lever 70 where the camshafts 34 are slidably engaged, and the cam grooves 72 are formed (cut) into a groove shape as portions to transfer the load that is applied to the operating portion 71 at the time of operating the lever 70 to the camshafts 34. In FIG. 15, the cam grooves 72 are formed into a generally V-like shape from a lower left part to the upper right side of the generally central part in the side surfaces of the lever 70 in the figure. The cam groove 72 has a pair of elbows 72c in the generally central part in the longitudinal direction, and with the pair of elbows 72c as borders, a left side section of the cam groove 72 in the figure is provided as a connector moving section 72a, and a right side section of the cam groove 72 in the figure is provided as an electric wire press contact sections 72b.

The connector moving sections 72a are sections where the camshafts 34 slide in the cam grooves 72 in a period since the lever 70 is rotatably assembled to the support portions 52 of the connector receiving portion 51 in a state that the connector 30 is engaged with the lever 70, the operating portion 41 is pushed, and the connector 30 starts to move towards the direction of the press contact blades 23 until the electric wires 31 start to abut and be press contacted with the press contact blades 23. In FIG. 15, the connector moving sections 72a extend from the lower left parts to the upper right in the side surfaces of the lever 70, are bent at the lower side of the generally central parts of the side surfaces of the lever 70 to form the elbows 72c, and are formed to follow the electric wire press contact sections 72b. With the shape of the above connector moving sections 72a, the elbows 72c are formed at lower positions in the height direction of the lever 70 in comparison with the case that the cam grooves are formed into a generally arc-like shape. The electric wire press contact sections 72b are sections where the camshafts 34 slide in the cam grooves 72 in a period since the electric wires 31 start to abut and be press contacted with the press contact blades 23 until the electric wires 31 have been press contacted with the press contact blades 23. The electric wire press contact sections 72b are formed to extend from the elbows 72c to the upper right sides of the generally central parts in the side surfaces of the lever 70 to stand up.

The cam grooves 72 are formed so that an angle between the direction the operating portion 71 is pushed down at the time of operating the lever 70 and the connector moving sections 72a is larger than an angle of the inclination of the electric wire press contact sections 72b. That is, in FIG. 15, when the direction the operating portion 71 is pushed down is shown with a straight line A and the inclination of the connector moving section 72a to the straight line A (the direction the operating portion 71 is pushed down) is shown with a straight line B, the angle of the inclination is x. When the inclination of the electric wire press contact sections 72b to the straight line A (the direction the operating portion 41 is pushed down) is shown with a straight line C, the angle of the inclination is y. The cam grooves 42 are formed so that the angle x is larger than the angle y.

Then, with reference to FIGS. 16 to 18, actions of the lever 70 and the connector 30 at the time of operating the lever 70 are described in detail.

In FIG. 16A, first, the rotation shafts 74 of the lever 70 are inserted into the shaft receiving grooves 52a in the support portions 52. The arc portions 75 of the rotation shafts 74 inserted into the shaft receiving grooves 52a abut with the shaft receiving walls 52c, and the upper half of the straight line portions 76 abut with the protruding walls 52d. When the rotation shafts 74 are assembled to the support portions 52, the bottom surface of the electric wire holder 32 abuts with the contact surface 53a, and the positioning of the connector 30 in the connector receiving portion 51 is completed.

In FIG. 16B, after the positioning of the connector 30 to the connector receiving portion 51 is completed, the angle of the inclination (the illustrated straight line B) of the connector moving sections 72a relative to the direction the operating portion 71 is pushed down (the illustrated straight line A) is x, and the angle of the inclination (the illustrated straight line C) of the electric wire press contact sections 72b relative to the direction the operating portion 71 is pushed down (the illustrated straight line A) is y. In this state, the angle x of the inclination of the connector moving sections 72a is larger than the angle y of the inclination of the electric wire press contact sections 72b.

In FIGS. 17A and 17B, when the operating portion 71 is pushed down towards the direction shown with an arrow A, the arc portions 75 of the rotation shafts 74 slide on the shaft receiving walls 52c, and part of the rotation shafts 74 enter into the groove portions 52b from the shaft receiving grooves 52a and rotate towards the direction shown with an arrow B. A load due to the pressing of the lever 70 is applied to the camshafts 34 through the cam grooves 72. Thereby, the camshafts 34 slide in the connector moving section 72a of the cam grooves 72, and the connector 30 starts to move towards the press contact blades 23 while the bottom surface of the electric wire holder 32 slides on the contact surface 53a. At the same time, the slider shafts 35 slide in the slider grooves 73 in the direction the connector 30 moves.

In FIGS. 17A and 17B, while the camshafts 34 arrive at the elbows 72c in the cam grooves 72, the connector 30 is inserted into the through portion 54a of the connection guide portion 54, and the electric wires 31 which are assembled to the electric wire holder 32 start to abut and be press contacted with the press contact blades 23. The electric wires 31 start to be press contacted in a state that the connector 30 turns to a regulated direction when the connector is connected due to the through portion 54a and the connection guide walls 54b. When the electric wires 31 start to be press contacted, the camshafts 34 stop sliding in the connector moving sections 72a, enter into the electric wire press contact sections 72b, and start sliding in the electric wire press contact sections 72b.

In FIG. 18A, when the operating portion 71 is further pushed down to the final point, the press contact blades 23 cut into the insulative sheaths of the electric wires 31, and are press contacted. By the above, the electrical connection of the connector 30 and the connector receiving portion 51 is completed. At the same time, the camshafts 34 abut with the fringes of the right ends of the cam grooves 72 in the figure, and stop sliding. The slider shafts 35 abut with the fringes of the right ends of the slider grooves 73 in the figure, and stop sliding. Furthermore, when the lever locking portions 77 are locked to the lever locked portions 55, the lever 70 is fixed to the housing 50. When the press contact of the electric wires 31 is completed, the angle of the inclination (the illustrated straight line C′) of the electric wire press contact sections 42b relative to the direction (the illustrated straight line A) the operating portion 71 is pushed down becomes y′.

Thus, the press contact blades 23 are connected to the conductors only by cutting into the insulative sheaths of the electric wires 31. Compared with the connecting structure in which connecting terminals accommodated in the connector 30 are contacted and conform to each other, the connector connecting structure 100 is finished with a smaller connection load.

Therefore, the load in the connection of the connector 30 and the connector receiving portion 51 can be reduced. The connector 30 is engaged to the lever 70 at totally four places of the pair of camshafts 34 and the pair of slider shafts 35. Thus, when the connector 30 is connected, it can be prevented that the connector 30 rotates relative to the lever 70.

In FIG. 16B, the angle of the inclination (the illustrated straight line B) of the connector moving sections 72a relative to the direction the operating portion 71 is pressed down (the illustrated straight line A) is larger than the angle of the inclination (the illustrated straight line C) of the electric wire press contact sections 72b relative to the direction the operating portion 71 is pressed down. Because the connector 30 is only moved towards the press contact blades 23 before the electric wires start to be press contacted, a load smaller than the load necessary for the press contact of the electric wires 31 is enough. Thereby, the angle of the inclination of the connector moving sections 72a before the electric wires start to be press contacted can be larger than the angle of the inclination of the electric wire press contact sections 72b, and the height of the cam grooves 72 can be lowered in the height direction of the lever 70.

According to the present embodiment, the elbows 72c are formed at lower positions in the height direction of the lever 70 in comparison with the case that the cam grooves are formed into a generally arc-like shape. Therefore, in FIG. 16B, the angle of the inclination (the illustrated straight line B) of the connector moving sections 72a relative to the direction the operating portion 71 is pressed down (the illustrated straight line A) can be larger than the angle of the inclination (the illustrated straight line B) of the connector moving sections 42a relative to the direction the operating portion 41 is pressed down (the illustrated straight line A) before the electric wires start to be press contacted in FIG. 11A of the first embodiment. Therefore, the height of the cam grooves 72 can be further lowered in the height direction of the lever 70.

Furthermore, the angle y′ in FIG. 18B is smaller when the angle y of the inclination of the electric wire press contact sections 72b relative to the direction (the illustrated straight line A) the operating portion 71 is pushed down in FIG. 16B and the angle y′ of the inclination (the illustrated straight line C′) of the electric wire press contact sections 72b relative to the direction (the illustrated straight line A) the operating portion 71 is pushed down in FIG. 18B are compared. Thereby, the effect of the slopes of the electric wire press contact sections 72b is raised after the electric wires start to be press contacted, and the load when the connector 30 and the connector receiving portion 51 are connected is lowered.

In FIGS. 16A to 18B, since the bottom surface of the electric wire holder 32 slides on the contact surface 53a at the time of operating the lever 70, the connector 30 can be moved towards the press contact blades 23 in a stable state, and the electric wires 31 can be press contacted to the press contact blades 23.

As described with reference to FIGS. 15 to 18B, according to the present embodiment of the above construction, operativity can be improved by reducing the load when the connector 30 is connected and preventing the rotation of the connector 30.

In addition, while the length of the cam grooves 72 necessary for connection of the connector 30 is maintained, the connector connecting structure 200 can be downsized.

The connector 30 can be connected to the connector receiving portion 51 in a stable state, and operativity can be improved.

The vehicle indoor lamp including the connector connecting structure 200 according to the present embodiment achieves the same effect as that of the connector connecting structure 200 of the above construction.

In addition, it is apparent that various modifications can be made to the invention without changing the purpose of the invention.

There is provided a connector connecting structure and a vehicle indoor lamp which includes the connector connecting structure so that the load in connecting connectors decreases and the rotation of the connectors is prevented so that operativity is improved. In addition, there is provided a connector connecting structure and a vehicle indoor lamp which includes the connector connecting structure so that while the length of the cam grooves necessary for connector connection is maintained, downsizing can be realized.

What is claimed is:

1. A connector connecting structure comprising:
a connector that is electrically connected from outside; and
a connector receiving portion to which the connector is connected,
wherein the connector is made by assembling an electric wire including a conductor and an insulative sheath to an electric wire holder, and exposing the electric wire at a side to be connected to the connector receiving portion,
the electric wire holder is provided with a camshaft, which is engageable to a lever to be assembled to the connector receiving portion, on side surfaces,
the lever is provided with a cam groove in which the camshaft is slidably engaged and a rotation shaft which is rotatably assembled to the connector receiving portion, at side face of the lever, and is provided with an operating portion with which the lever is pressed down to assemble the rotation shafts to the connector receiving portion, at one end side of a top face of the lever,
the connector and the lever further include a slider shaft which prevents the rotation of the connector at the time of operating the lever at one of the side face of the connector and the side face of the lever, and a slider groove to which the slider shaft is slidably engaged at the other of the side face of the connector and the side face of the lever,
the connector receiving portion has a support portion to which the rotation shaft of the lever is rotatably assembled, and a press contact blade to which the electric wire is press contacted, and
when the rotation shaft of the lever is assembled to the support portion and the operating portion is pushed down, the camshaft slides in the cam groove to make the connector move to the connector receiving portion, and the slider shaft slides in the slider grooves to prevent the rotation of the connector, and when the electric wire is cut into by the press contact blade, the electrical connection of the connector and the connector receiving portion is completed.

2. The connector connecting structure according to claim 1, wherein the cam groove has a connector moving section in which the camshaft slides to make the connector move towards the connector receiving portion, and a electric wire press contact section in which the camshaft slide to make the electric wire to be cut into by the press contact blade to be press contacted, and
in the cam groove, an angle of an inclination of the connector moving section relative to the direction in which the lever is pushed down is larger than the angle of the inclination of the electric wire press contact section.

3. The connector connecting structure according to claim 1, wherein the connector receiving portion includes a contact surface that is formed to be perpendicular to the direction in which the lever is pushed down, and
the connector moves to the press contact blade when a bottom face of the electric wire holder slides on the contact surface at the time of operating the lever.

4. The connector connecting structure according to claim 2, wherein the connector receiving portion includes a contact surface that is formed to be perpendicular to the direction in which the lever is pushed down, and
the connector moves to the press contact blade when a bottom face of the electric wire holder slides on the contact surface at the time of operating the lever.

5. A vehicle indoor lamp comprising the connector connecting structure according to claim 1.

6. A vehicle indoor lamp comprising the connector connecting structure according to claim 2.

7. A vehicle indoor lamp comprising the connector connecting structure according to claim 3.

8. A vehicle indoor lamp comprising the connector connecting structure according to claim 4.
